(19) United States
(12) Patent Application Publication
(10) Pub. No.: US 2011/0153342 A1
(43) Pub. Date: Jun. 23, 2011

(54) Nonprescription Medication Consumer Tool

(76) Inventor: John Rose, Milwaukee, WI (US)

(21) Appl. No.: 12/641,081

(22) Filed: Dec. 17, 2009

(51) Int. Cl. G06Q 50/00; G06Q 30/00; G06F 17/30; G06F 3/16; G06F 3/041

(52) U.S. Cl. 705/2; 707/825; 715/728; 345/173; 707/E17.009; 707/E17.032

(57) ABSTRACT

The present invention is a nonprescription medication consumer tool for selecting nonprescription medications which allows an individual to select his or her symptoms and contraindications to determine a suitable nonprescription medication. The symptoms, contraindications and information provided to the individual, such as dosing and warnings, are provided in layperson's terms. The nonprescription medication consumer tool may be available to individuals as a website and/or mobile device application or as part of a vending system or dispensing machine.

### CROSS-REFERENCE TO RELATED APPLICATIONS

None

### FIELD OF INVENTION

The present invention relates to an apparatus configured with software to assist a consumer in selecting a nonprescription medication in lieu of speaking with a medical professional.

### BRIEF DESCRIPTION OF THE DRAWINGS

FIG. 1a illustrates an exemplary embodiment of a nonprescription medication consumer tool (NMCT) comprised of a user interface and a local database.

FIG. 1b illustrates an exemplary embodiment of a NMCT having a user interface which is mounted on a store shelf.

FIG. 1c illustrates an exemplary embodiment of a NMCT that is free-standing.

FIG. 2 illustrates an exemplary embodiment of a NMCT comprised of a user interface, a local database and a remote database.

FIGS. 3a through 3c illustrate exemplary embodiments of user interfaces for a NMCT.

FIG. 4 illustrates an exemplary database configuration for an exemplary embodiment of a NMCT.

FIG. 5 illustrates an exemplary embodiment of a NMCT implemented on a mobile communication device.

FIG. 6 illustrates an exemplary embodiment of a NMCT implemented as part of a vending system.

### GLOSSARY

As used herein, the term “active ingredients database” means a database or table capable of being queried containing the chemically or biologically active substance(s) of a medication which may be queried by active ingredient.

As used herein, the term “advertising and promotion database” means a database or table capable of being queried which contains information about pricing and sales, coupons, specials, promotions, buying opportunities, discounts, advertising copy, discussion of benefits, social data and other information which would could potentially influence a consumer purchase.

As used herein, the term “contraindication database” means a database or table capable of being queried that contains conditions, factors and/or known side effects that increase the risks involved in using a particular drug.

As used herein, the term “dosing database” means a database capable of being queried which includes criteria relevant to doses of medications appropriate for the physical characteristics of a user, including, but not limited to weight age, drug interaction potential, timing, symptom severity, type of medication, strength and quality of medication, user activity, timing or any other relevant information which may form the basis of a dosing query.

As used herein, the term “FDA database” means a database capable of being queried which contains information relevant to FDA actions.

As used herein, the term “interactively receive” means accepting and dynamically processing personalized user input in real time.

As used herein, the term “insurance database/table” means a database or table which refers to a listing which coordinates an individual's insurance coverage with particular medications and/or drug manufacturers.

As used herein, the term “inventory database” means a database or table with information relevant to availability and pricing of medication. Inventory database information may include price, available quantities, promotional information or any other information or criteria capable of forming a query relevant to availability or accessibility of a nonprescription medication.

As used herein, the term “legal database/table” means a database or table of information capable of being queried pertaining to the law, such as indemnification information for products liability and information regarding false claims.

As used herein, the term “patient identification card” refers to a card having a magnetic strip which stores personal medical information that can be read and accessed by a NMCT.

As used herein, the term “personal data” or “personal medical information” refers to the characteristics of an individual, such as body weight, known allergies, medical history, medications which the individual is currently taking and previously diagnosed illnesses or diseases.

As used herein, the term “pharmacy area” means an area where a professional pharmacist is employed, which may or may not be within a retail location.

As used herein, the term “pricing database” means a database or table which includes price, available quantities, promotional information or any other information or criteria capable of forming a query relevant to availability or accessibility of a nonprescription medication.

As used herein, the term “promoter database” or “physician database” means a database or table containing information (e.g., personalized web pages of individuals and promoters, such as physicians and pharmaceutical companies.)

As used herein, the term “point of purchase” means a retail location, pharmacy or Internet enabled environment from which a consumer of a nonprescripton drug may potentially initiate a purchase.

As used herein, the term “retail location” means an area which is open to the public and which sells products.

As used herein, the term “revenue database/table” means a database or table which contains information relevant to tracking the income or number of subscriptions received by a particular individual or organization.

As used herein, the term “side effects database” means a database or table which contains information relevant to known effects of a medication other than its intended effect.

As used herein, the term “symptom database/table” refers to a collection of symptoms including, but not limited to pain and fever disorders, reproduction and genital disorders, respiratory disorders, gastrointestinal disorders, nutrition and nutritional supplementation, ophthalmic disorders, otic disorders, oral disorders, dermatologic disorders and other medical disorders.

As used herein, the term “symptom information/video database/table” refers to a listing of available narratives regarding symptoms.

As used herein, the term “teen abuse database/table” refers to a collection of data regarding medications which are habitually used by teenagers for non-medical purposes.

As used herein, the term “trademark database/table” refers to a listing which tracks the trademarks of the included medication and their permission to use.

As used herein, the term “users” refers to individuals, including but not limited to consumers and health care professionals.

As used herein, the term “user interface” means aspects of a computer system or program which can be seen, heard, or otherwise perceived by a user, and the commands and mechanisms the user uses to control its operation and input data, and to receive and display data to/from a user including, but not limited to a screen, touch screen voice recognition technology, a holographic keyboard, a bar code reader, an Internet based web interface, a biological sensor, an electronic sensor or any other apparatus known in the art for receiving user input.

As used herein, the term “user profile” means identifying data about a user and information, such as their prescription and nonprescription medication history.

As used herein, the term “voice recognition technology” means a technology which can covert voice or sound waves to data and/or which can covert data voice/sound waves.

Background

The nonprescription drug market in the U.S. alone is estimated to exceed $20 billion dollars a year. Over-the-counter cold and cough medication sales alone in 2009 exceeded $4.4 billion.

Pharmacists are instrumental to marketing and choices consumers make in purchasing nonprescription drugs. Often, it is the on-premise availability of a pharmacist that causes a consumer to purchase a nonprescription medication at particular location.

When a consumer makes a nonprescription drug purchase, he or she is brought to the premises of a retailer to purchase other products, supplies and impulse items.

Pharmacists receive millions of inquiries each day regarding symptoms and appropriate nonprescription drugs, requiring a significant amount of time on the part of pharmacists. Often, there are lines and processing backlogs as pharmacists attempt to meet consumer needs in this area.

Contributing to the demands on pharmacist time are advertising programs, which advertise the availability of on-premises pharmacy services to drive consumers to retail locations.

In high density retail locations, pharmacists and consumers may have an increased risk of medical error. Both prescription and nonprescription medications may cause harmful side effects as a result of an individual's underlying medical condition, allergies, or use with other medications. The risk of harmful side effects is potentially higher for nonprescription medications due to the absence of doctor supervision and the perception that nonprescription medications are less harmful simply because they are available without a prescription.

Patients may also inadvertently take multiple nonprescripiton drugs containing the same active ingredient, which could lead to an overdose or increased side-effects. In other cases, patients may take more than the recommended dose of a drug, as they may not read or understand the directions, or they may choose to ignore them, believing a higher dose to be more effective.

While many nonprescription drugs have wide therapeutic ranges, some may pose greater risks if not used as directed. For example, acetaminophen is regulated as a nonprescription drug in many countries and is widely regarded as safe if used as directed, but it can cause acute liver failure if recommended doses are exceeded and/or if combined with alcohol. This problem is further compounded by the plethora of nonprescription products containing acetaminophen, as patients may inadvertently overdose by taking multiple drugs (e.g., an individual with a common cold may take two acetaminophen-containing products, one to treat muscle aches, the second for a fever, without realizing that both products contain acetaminophen).

The FDA requires that nonprescription drug products be labeled with an approved drug facts label to educate consumers about the medications. These labels comply to a standard format and are intended to be easy for the typical consumer to understand. Drug facts labels include information on the product's active ingredient(s), indications and purpose, safety warnings, directions for use, and inactive ingredients.

There are websites currently available that provide information about nonprescription drugs (e.g., http://www.mayoclinic.com/health/drug-information/DrugHerbIndex, http://www.webmd.com/drugs/index-drugs.aspx). These websites provide information on prescription medications, nonprescription drugs and symptoms; however, they do not allow an individual to input personal information, such as symptoms, existing medical conditions and current medications, provide contraindications in order to help the individual select a suitable nonprescription drug, or allow access to a full range of data that may be relevent to a particular consumer.

It is desirable to have a nonprescription medication tool which can provide information to a consumer on the premises of a retail establishment (or over the Internet) to supplement on-premises pharmacy services.

It is further desirable to have an interactive consumer tool that can supplement existing revenue and advertising programs.

It is further desirable to have a nonprescription medication tool which can act as a vending system designed to interactively receive medical data.

### SUMMARY OF THE INVENTION

The present invention is a nonprescription medication consumer tool (NMCT) for selecting nonprescription medications.

In various embodiments, the NMCT can provide information to a consumer on the premises of a retail establishment to supplement on-premises pharmacy services and can supplement existing revenue and advertising programs.

In various embodiments, an individual may select his or her symptoms and contraindications to determine a suitable nonprescription medication. The symptoms, contraindications and information provided to the individual, such as dosing and warnings, are provided in layperson's terms. The NMCT may be available to individuals as a website and/or mobile device application, or as part of a vending system or dispensing machine.

The NMCT is further capable of associating an individual's symptoms, medical condition, current medications and contraindications with the active ingredients of other medications in order to select a suitable nonprescription drug and to identify factors that would direct a consumer to a particular nonprescription drug option.

In various embodiments, the NMCT may also be capable of monitoring and updating formulations and monitory information in a central repository.

In various embodiments, the NMCT, which serves as a revenue and advertising model, may independently generate revenue, drive retail customers to desired locations and alert customers of pricing and other data that can direct a consumer's choice of a nonprescription medication.

### DETAILED DESCRIPTION OF INVENTION

For the purpose of promoting an understanding of the present invention, references are made in the text to exemplary embodiments of a nonprescription medication consumer tool, only some of which are described herein. It should be understood that no limitations on the scope of the invention are intended by describing these exemplary embodiments. One of ordinary skill in the art will readily appreciate that alternate, but functionally equivalent databases and interfaces may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

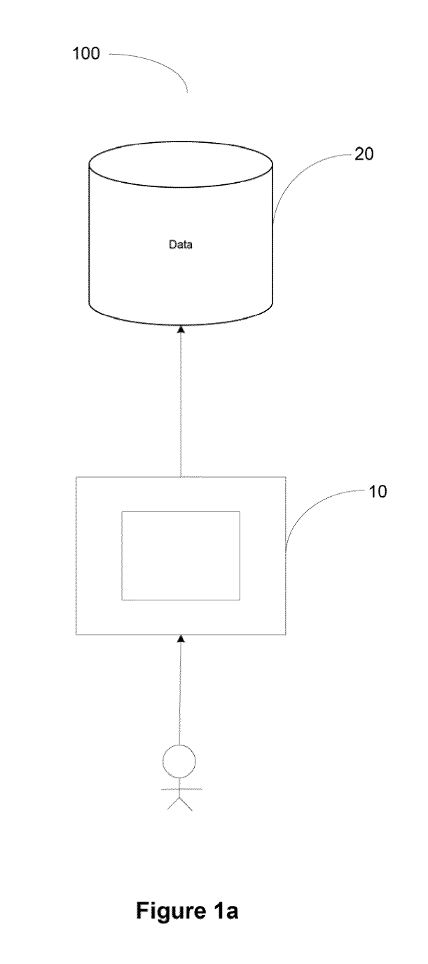

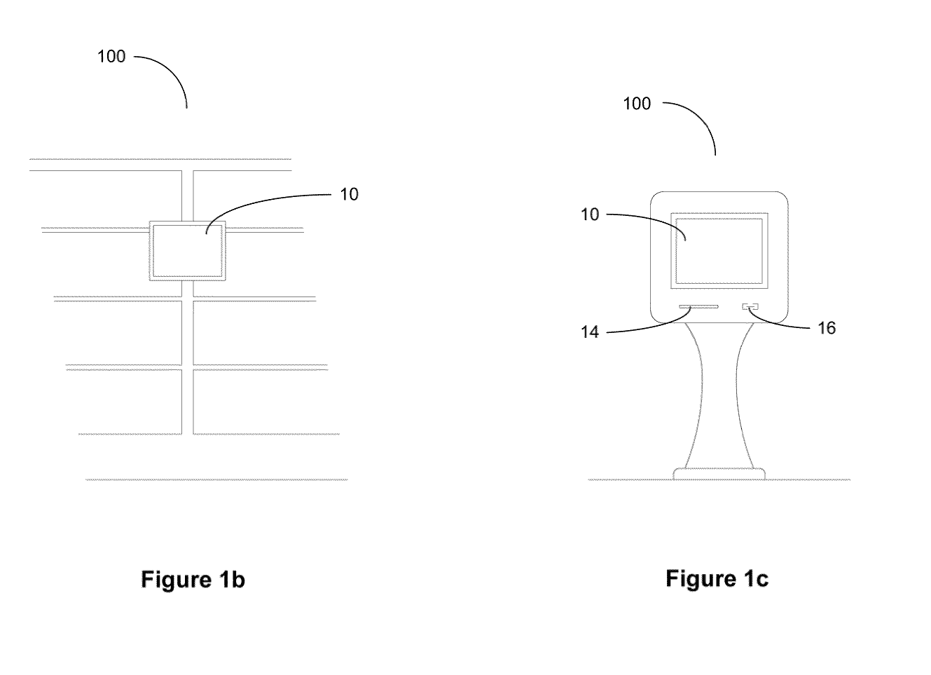

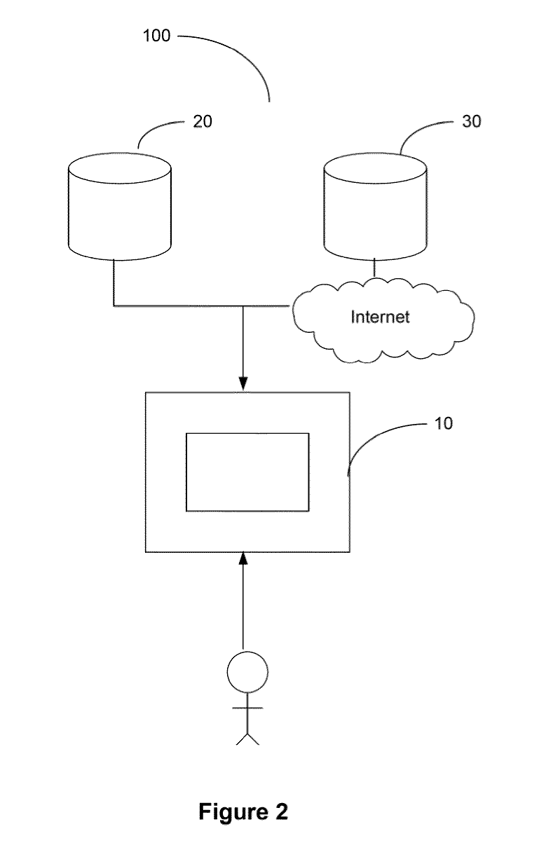

FIG. 1a illustrates an exemplary embodiment of nonprescription medication consumer tool (NMCT) 100 comprised of user interface 10 and local database 20. In the embodiment shown, local database 20 is configured with software to receive and assess user input from user interface 10 and to dynamically query local database 20.

In various embodiments, queries may relate to information including, but not limited to symptoms, precautions, indications, contraindications, dosing, inventory, directions or usage, side effects, teen abuse data, sales and promotion data, advertising data, interaction data, coupons or any other information that may be relevant to a user.

In the embodiment shown, user interface 10 is comprised of an interface which may be a computer screen and/or a website with a series of web pages and prompts that prompt a user to make selections from a list. For example, on one web page, the user may be prompted to select his or her symptoms or the symptoms of a patient. On another web page, the user may be prompted to select contraindications.

Other embodiments may include one or more web pages which obtain more information from the user (e.g., current medications, medical history) or provide additional information to the user. For example, additional information, such as dosing information, drug availability, locations where the drug may be purchased and cost may be displayed on an additional web page(s). A message guiding the patient to a pharmacist where there is a drug interaction may also be displayed.

In other embodiments, NMCT 100 has the ability to track pharmacist-patient interaction to allow for Medicare and/or Medicaid reimbursement.

FIG. 1b shows an alternate embodiment of NMCT 100 configured as an apparatus physically located in a retail environment. In the embodiment shown, NMCT 100 is comprised of user interface 10, which is a screen directly mounted on or near a store shelf. Multiple NMCTs 100 may be placed near a particular type of nonprescription drug or in the nonprescription medication section of a retail environment. Various embodiments may further include a coupon printer known in the art (not shown). A consumer, using this embodiment may, for example, desire to select among various cold medications in a particular section of the store. The user may be prompted to enter personal data, such as symptoms, age, weight, demographic information, other medications he or she is currently taking, existing medical condition(s), etc. The NMCT 100 may then identify a list of medications based on the user's input, and may further identify cost, sales, promotional and other data allowing the consumers to select the most cost-effective and appropriate medication and/or avail themselves of a promotion. Alternatively, NMCT 100 may access a user profile containing this information. The user profile may be stored in a remote database or in a retail computer LAN or WAN (not shown). Advertising may appear on user interface 10, or be provided by another overt or subliminal cueing method in order to influence a user to make a particular choice from among equally effective medications having similar costs.

FIG. 1c illustrates a free-standing embodiment of NMCT 100 adapted to be placed near a pharmacy or other location in a retail environment. The structure may include an interface adapted with a touch screen and information cues, voice-activated features, a barcode scan, a fingerprint or retinal scan or any other interface known in the art adapted to receive and configure user input.

The free-standing embodiment of NMCT 100 may also be located in a non-retail environment. For example, NMCT 100 may be located in a nursing home or assisted living facility where a resident who is unable to visit a pharmacy or other retail location could use NMCT 100 to input personal medical information and select an appropriate nonprescription medication. The nonprescription medication could then be picked up by a caregiver.

In the embodiment shown, NMCT 100 further includes a printer (not shown), printer slot 14 for retrieving a printout, and card reader 16 for accepting and reading a card with a magnetic strip. For example, card reader 16 may be used to accept payment by credit card or to read a patient identification card storing personal medical information. If a patient identification card is inserted, the NMCT 100 would access the user's personal medical information and allow the user to update his or her information, if necessary (e.g., symptoms), without requiring the user to reenter all relevant information. When the patient identification card is removed, the user's personal medical information would be inaccessible to subsequent users.

FIG. 2 illustrates an exemplary embodiment of NMCT 100 comprised of user interface 10, local database 20 and remote database 30. In the embodiment shown, remote database 30 performs updates and stores information including, but not limited to user profiles, recall notices, product formulation changes, manufacturer instructions, manufacturer information, manufacturer promotions, FDA information, program updates, software modifications, changes in feedback and therapy recommendations, medication effectiveness, side effects, drug-drug interactions, drug-herbal supplement interactions, warnings, dosing information, demographic consumer information compiled from consumers who use NMCT 100 in retail environments where such information is stored and compiled, newsletters, community information, health alerts, information about diseases (e.g., influenza) and other relevant information relevant to a consumer choice.

Remote database 30 communicates with multiple NMCT 100 user interfaces 10 to update information related to user profiles, recall notices, product formulation changes, manufacturer instructions, manufacturer information, manufacturer promotions, FDA information, program updates, software modifications, changes in feedback and therapy recommendations, medication effectiveness, side effects, drug-drug interactions, drug-herbal supplement interactions, warnings, dosing information, demographic consumer information compiled from consumers who use NMCT 100 in retail environments where such information is stored and compiled, newsletters, community information, health alerts, information about diseases (e.g., influenza) and other relevant information relevant to a consumer choice. Remote database 30 may also include revenue and payment processing components, either for use of the services of NMCT 100 or for ordering of nonprescription medications.

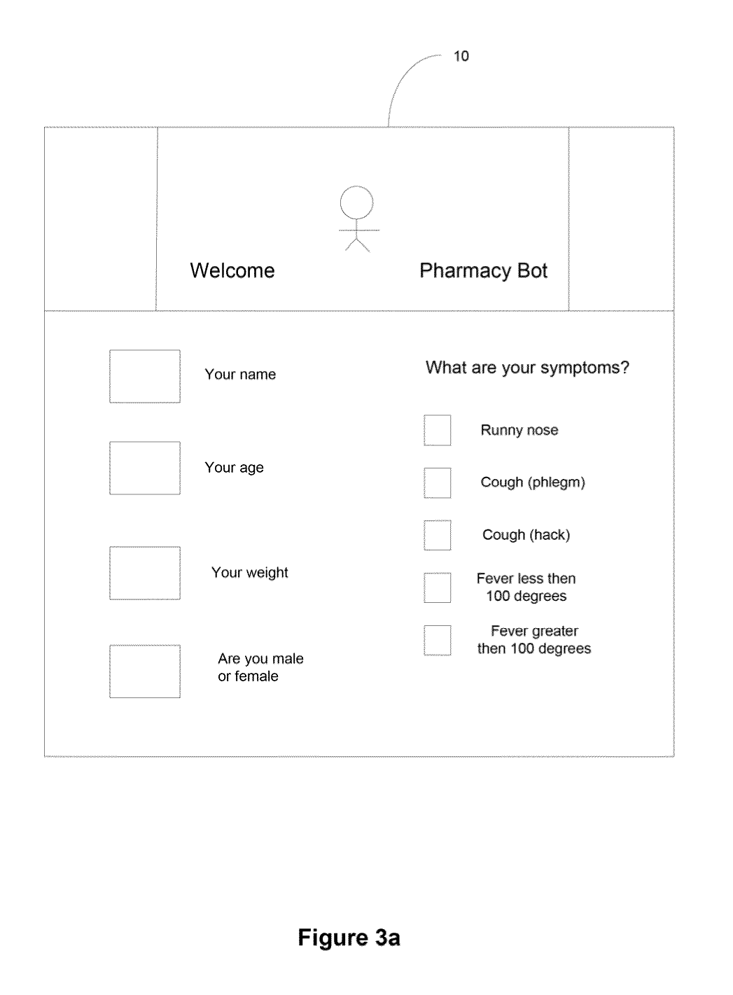

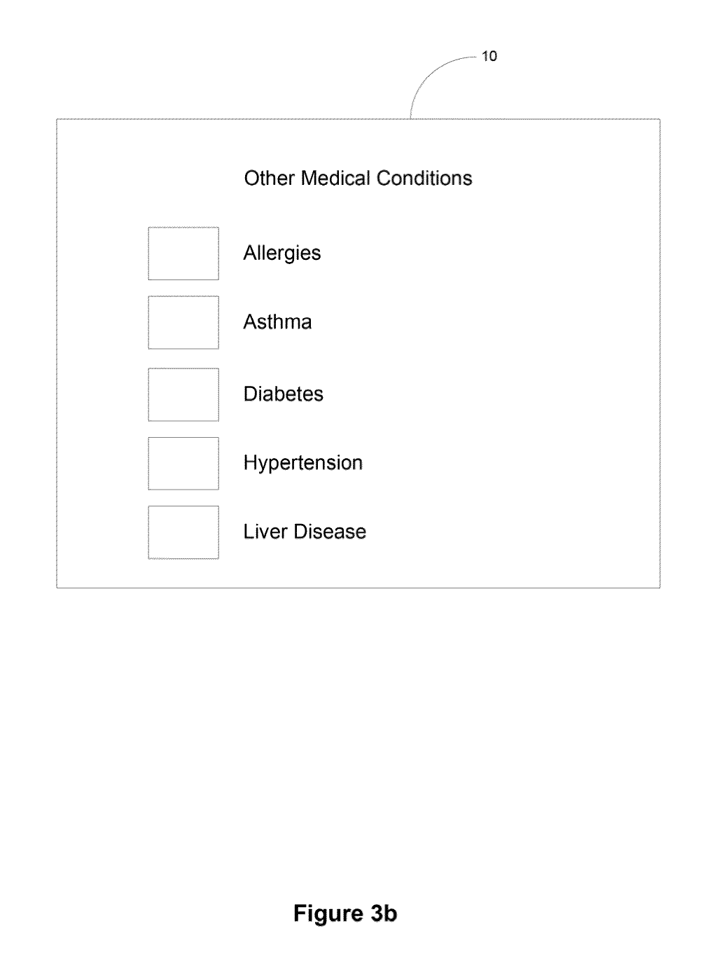

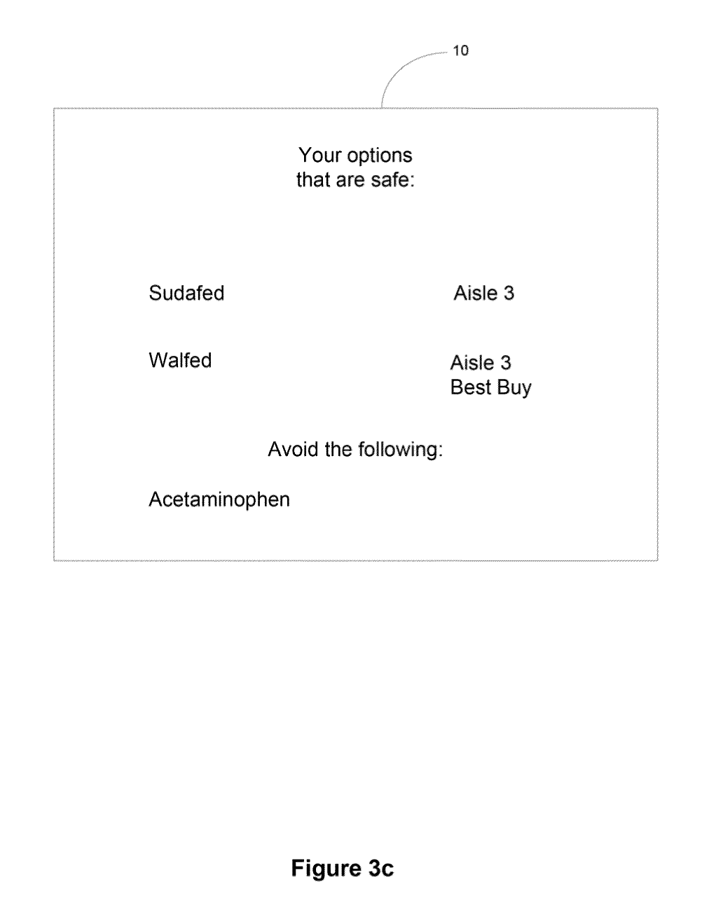

FIGS. 3a through 3c illustrate exemplary user interfaces for NMCT 100 including exemplary informational fields which may be used to prompt a user to formulate a query or provide personal information to generate and display an updated user interface (or printout) providing information relative to a nonprescription medication. In various embodiments, information entered may include name, age, indications, contraindications, health considerations, demographic information, retail location data, survey and buying preference data, identification verification data, ordering information, etc. Information displayed may include, but is not limited to available medications, interactions, symptoms, warnings, coupons, price availability, and promoter data.

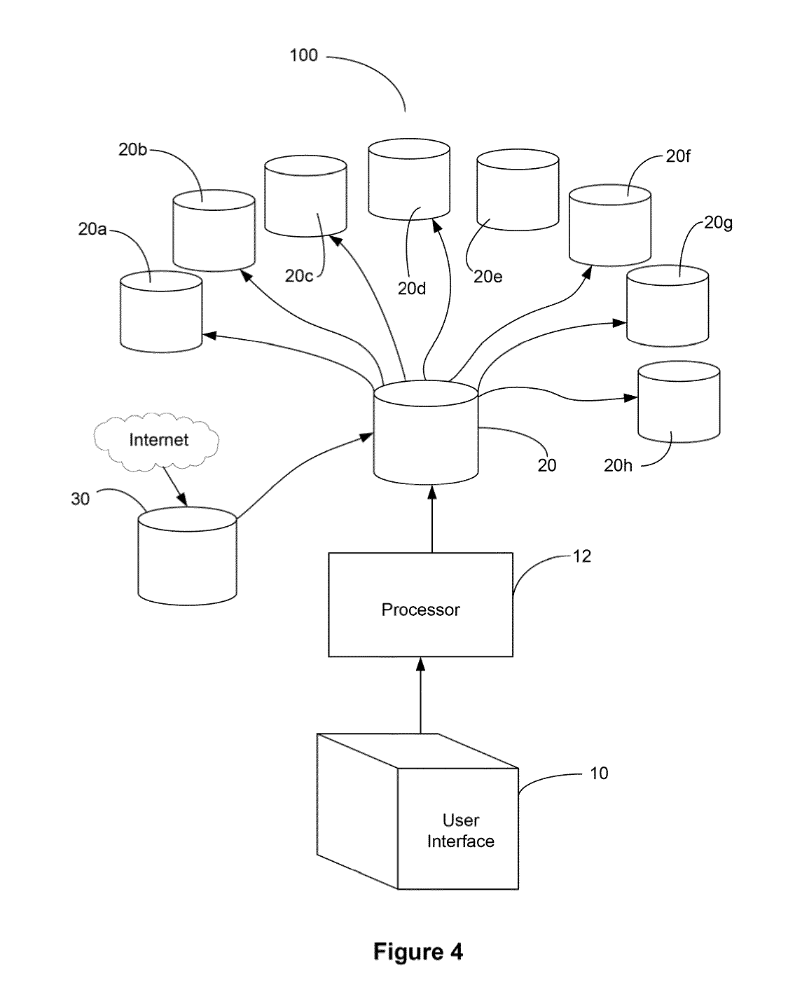

FIG. 4 illustrates an exemplary embodiment of NMCT 100 comprised of user interface 10, processor 12, local database 20 and remote database 30.

The exemplary embodiment shown includes contraindication database 20a, medication database 20b, interaction database 20c, personal profile information database 20d, consumer marketing database 20e, pricing and promotional database 20f, store inventory database 20g, and promoter database 20h which may be simultaneously queried and updated periodically.

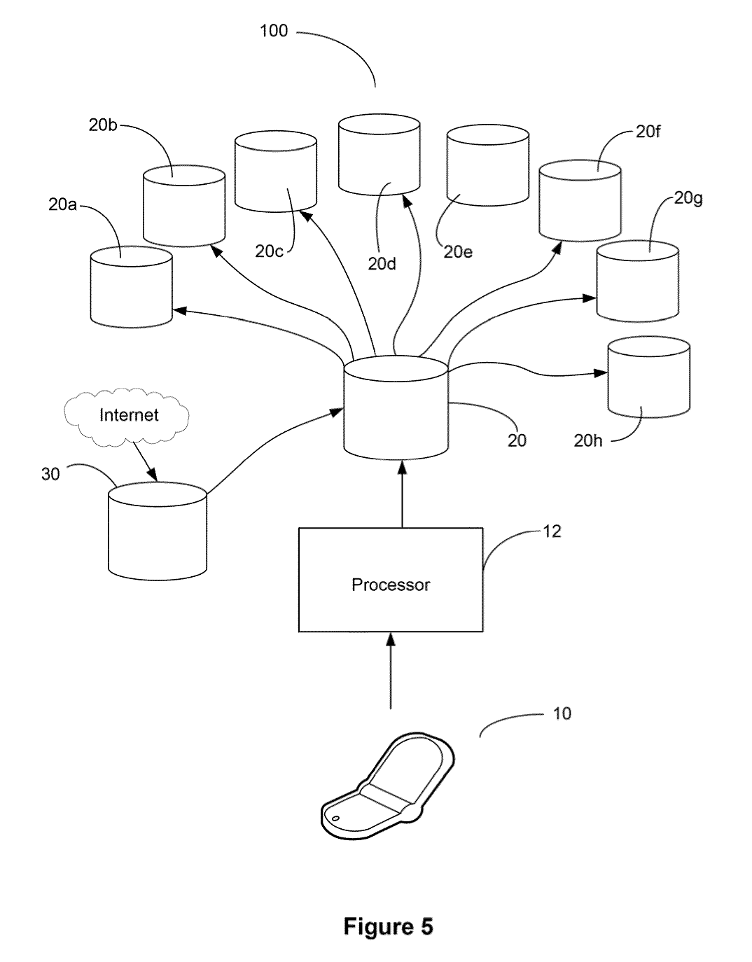

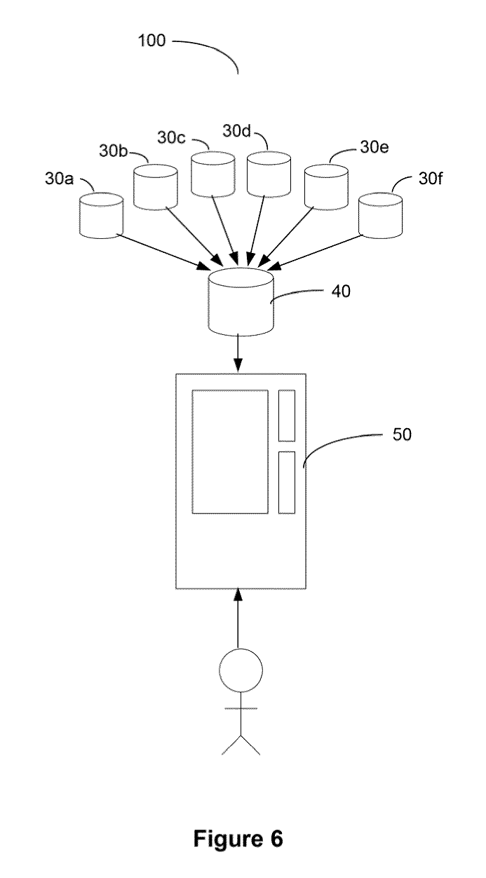

FIG. 5 illustrates an exemplary embodiment of NMCT 100 comprised of user interface 10, processor 12, local database 20 and remote database 30. In the embodiment shown, user interface 10 is a mobile communication device.

FIG. 6 illustrates an exemplary embodiment of NMCT 100 comprised of vending machine 50 and central database 40. In the embodiment shown, central database 60 queries multiple remotes databases 30a-30f to assist and/or direct a consumer choice in obtaining a nonprescription medication.

What is claimed is:

1. The nonprescription medication consumer tool comprised of:
at least one user interface adapted to interactively receive personal medical information from a potential consumer of a nonprescription medication at a point-of-purchase;
at least one database containing information about nonprescription medications; and
at least one processor which queries said at least one database to match an appropriate nonprescription medication with said at least one user.

2. The nonprescription medication consumer tool of claim 1 which further includes a remote database which performs backend processing functions and modifies data located on said nonprescription medication consumer tool.

3. The nonprescription medication consumer tool of claim 2 wherein said remote database performs backend processing functions on data selected from a group consisting of user profile data, recall notice data, product formulation change data, manufacturer instruction data, manufacturer information data, manufacturer promotions data, FDA information data, program updates data, software modifications, feedback and therapy data, effectiveness data, side effects data, warnings data, dosing information data, demographic consumer information data, user preference data and consumer data.

4. The nonprescription medication consumer tool of claim 1 which further includes a software component to update user information selected from a group consisting of user profile, recall notices, product formulation changes, manufacturer instructions, manufacturer information, manufacturer promotions, FDA information, program updates, software modifications, feedback and therapy recommendations changes, effectiveness, side effects, warnings, dosing information, demographic consumer information compiled from consumers, newsletters, community information, health alerts, indications and contraindications.

5. The nonprescription medication consumer tool of claim 2 wherein said remote database is configured with software to store user profiles in real time when a user enters updated user profile information and which is further adapted to compare said updated user profile information to data selected from a group consisting of contraindication data, side effect data, medical condition data, recall data, drug warning data, indication data, historical user data, teen abuse data, identification data, user preference data and combinations thereof in real time.

6. The nonprescription medication consumer tool of claim 2 which is configured with software to transfer marketing data from said remote database to said local database.

7. The nonprescription medication consumer tool of claim 6 wherein said marketing data is selected from a group consisting of manufacturer promotions, retail chain promotions, discounts, coupon data, award program data and incentive program data.

8. The nonprescription medication consumer tool of claim 1 which further includes a housing adapted for mounting on a store shelf.

9. The nonprescription medication consumer tool of claim 1 which further includes a structural support component and housing adapted to render said nonprescription medication tool capable of being located in proximity to a pharmacy area in a retail location.

10. The nonprescription medication consumer tool of claim 1 which is adapted to connect to at least one central database via the Internet.

11. The nonprescription medication consumer tool of claim 1 in which said user interface is adapted to receive user input via voice recognition.

12. The nonprescription medication consumer tool of claim 1 in which query results are communicated to a user through an auditory component which emulates human speech.

13. The nonprescription medication consumer tool of claim 1 in which said user interface is a mobile communication device.

14. The nonprescription medication consumer tool of claim 1 which further includes a vending component which is configured with software to dispense a medication after processing user input including said personal medical information.

15. The nonprescription medication consumer tool of claim 1 which further includes the capability to compile information about users' preferences and user activity for marketing research purposes.

16. The nonprescription medication consumer tool of claim 1 wherein said user interface is a touch screen and which further includes a vessel containing a substance which may be used for cleaning said screen to reduce the spread of infection.

17. A distributed nonprescription medication communication system apparatus comprised of:
at least one user interface adapted to interactively receive personal medical information from a potential consumer of a nonprescription medication at a point-of-purchase;
at least one database containing information about nonprescription medications;
at least one processor which queries said at least one database to match an appropriate nonprescription medication with said at least one user based on said personal medical information; and
at least one remote database which performs backend processing functions and modifies data located on a plurality of nonprescription medication tools in real time.

18. The distributed nonprescription medication communication system of claim 17 which is configured to update data located on multiple geographically distributed databases, said data being selecting from a group of databases consisting of active ingredients database, advertising and promotion database, contraindication database, dosing database, FDA database, legal database, insurance database, inventory database, pricing database, promoter database, physician database, revenue database, side-effects database, teen abuse database, trademark database, symptom database and video database.
